(19) United States
(12) Patent Application Publication
(10) Pub. No.: US 2026/0043312 A1
(43) Pub. Date: Feb. 12, 2026

(54) CONVERSION OF A CARRIER SERVICE RIG TO A TRAILER SERVICE RIG

(71) Applicant: Axis Energy Services, LLC, Dallas, TX (US)

(72) Inventors: Joe Ray HALL, Gainesville, TX (US); Eric NEU, Lindsay, TX (US); Clayton Gary HOLLAND, Bryan, TX (US)

(21) Appl. No.: 19/291,573

(22) Filed: Aug. 5, 2025

Related U.S. Application Data
(60) Provisional application No. 63/679,606, filed on Aug. 5, 2024.
(60) Provisional application No. 63/746,556, filed on Jan. 17, 2025.
(60) Provisional application No. 63/810,272, filed on May 22, 2025.

(51) Int. Cl. E21B 41/00; B62D 63/08; E21B 15/00; E21B 19/00

(52) U.S. Cl. CPC E21B 41/00; B62D 63/08; E21B 15/00; E21B 19/008

(57) ABSTRACT

A method of converting a carrier rig to a trailer rig is provided. The carrier rig has a carrier rig chassis, a suspension system, a transport system, and rig service equipment. The method includes removing one or more of the suspension system, the transport system, or the rig service equipment. The method also includes attaching a chassis extension to the carrier rig chassis to form a trailer rig chassis of the trailer rig. The chassis extension is configured to couple to a transport vehicle.

### CROSS-REFERENCE TO RELATED APPLICATIONS

This application claims the benefit of priority of U.S. Provisional Patent Application No. 63/810,272, filed on May 22, 2025; claims the benefit of priority of U.S. Provisional Patent Application No. 63/746,556, filed on Jan. 17, 2025; and claims the benefit of priority of U.S. Provisional Patent Application No. 63/679,606, filed on Aug. 5, 2024, each of the above applications is incorporated herein by reference in its entirety.

### BACKGROUND

### Field

Embodiments of the present disclosure generally relate to rigs, such as drilling or service rigs, and particularly to the conversion of a service rig to a trailer rig.

### Description of the Related Art

Service rigs, also called workover rigs, are used in the oil and gas industry for land-based wells involving maintenance, service work, intervention, stimulation, plug drill out, plug and abandonment, or other well service applications. Workover rigs usually include a collapsible derrick or mast, a drawworks, winches, a diesel engine or an electric motor for powering the drawworks, stabilizing arms and jacks to level and stabilize the rig along with other usual equipment necessary for performing normal wellsite service activities. Because of the workover rig's smaller size and weight as compared to a regular, full-sized land well construction rig that is transported to a wellsite in sections and assembled on location, the workover rig is road transportable and able to quickly and easily access land wells in need of service. The workover rig is usually about the size of a full-sized flatbed truck or flatbed trailer pulled by a semi-truck tractor.

Workover rigs can be driven from location to location having a motorized transportation power system, known as a carrier service rig, carrier workover rig, carrier rig or mobile rig 10 as shown in FIG. 1. The carrier rig has a self-contained transport system for enabling the rig to be moved from one location to the other under its own power. The transport system has a source of power, usually a diesel engine with at least one fuel tank, a transmission connected to the diesel engine usually located towards the front end which leads when driven down a road. Further, usually on the front end is a steering system with one or more steering axles with wheels to maneuver the rig to the right and left, and a driver interface to the transport power source and steering system along with a steering wheel, pedals and operational buttons and levers. The front of the rig where the driver interface is located is usually covered by cab and with a driver's seat. The transport system includes all the equipment and devices needed to move the carrier rig from one location to another.

A drivetrain transfers power from the diesel engine through the transmission to driving wheels usually located on one or more driving axles with wheels located toward a rear of the rig, opposite the front end. The diesel engine used for transport may also mechanically power the drawworks or other equipment on the rig. In another configuration, a separate diesel engine is used to power the drawworks and other equipment. The rear of the rig may further include one or more support axles located next to the driving axles that help support the rig's heavy weight during transport. The rear end of the carrier rig includes a collapsible derrick and a derrick base, drawworks, winches. When collapsed, the derrick lays down horizontally and extends from the rear of the rig to the front, even extending past the front of the carrier rig cab. Along the length of the carrier rig are other pieces of equipment such as hydraulic pumps and motors, stabilizing arms and jacks along with other usual equipment necessary for performing normal wellsite service activities. A braking system, controlled by the driver through a pedal, provides braking for front and rear axles. The braking system may include a parking system. The brakes on a carrier rig are usually pneumatically operated. Since the carrier workover rig is roadworthy and approved to be self-propelled, it is classified and licensed as a motor vehicle.

Workover rigs can also be in the form of a trailer. Unlike the carrier rig, the trailer rig 20 as shown in FIG. 2 does not have a self-contained transport system but must be pulled from one location to another by a transport vehicle 21, such as a tractor, or any suitable towing vehicle. The trailer workover rig has all the equipment for wellsite service work like the carrier workover rig. The trailer rig 20 shown in FIG. 2 has been constructed new, from the ground up, as a trailer rig. The trailer workover rig 20 includes a collapsible derrick or mast, drawworks, winches, a diesel engine or an electric motor for powering the drawworks, stabilizing arms and jacks along with other usual equipment necessary for performing normal wellsite service activities. The service equipment is usually located on the rear of the trailer, or end that follows when pulled down the road. The front end of the trailer workover rig is configured to attach to the transport vehicle 21. The trailer rig further includes a braking system that operatively connects to the towing vehicle. The braking system is usually operated by pneumatics, controlled at the transport vehicle 21 or towing vehicle. Since the trailer rig is not considered a vehicle, the classification, licensing, insurance and regulations are different from that of a carrier workover rig.

There are some advantages of the trailer rig 20 over the carrier rig 10. The carrier workover rig 10 has more equipment to maintain. The transport power source, transmission, steering system, drivetrain and driving axles all have to be maintained for each rig. If a fleet of carrier rigs is considered, the purchase price and maintenance costs can multiply. For a trailer workover rig 20, the cost of maintenance on the rig itself does not include maintenance on the transport power source, steering system, transmission, drivetrain, driving axles, and driver interface. A single the transport vehicle 21 can transport multiple trailer rigs to and from different locations. This reduces the total cost for a fleet of workover rigs. Licensing and insurance may also be lower for a trailer rig as compared to a carrier workover rig.

The problems for the service rig industry is the population of workover rigs has significantly more carrier workover rigs 10 than trailer rigs 20. Historically, the trailer rig has been built new from scratch as a trailer rig and the carrier rig has been built new from scratch as a carrier rig. There is need in the service rig industry to reduce the maintenance costs as the number of rigs in the fleet increase. If a carrier rig's service equipment which includes the derrick, drawworks, rig floor, winches, drawworks powering equipment, either a diesel engine or an electric motor and the other service equipment were to be simply placed on a new flatbed trailer, the trailer may not be suited, and it may not be feasible if size, strength and weight calculations became an issue. Therefore, there would be an advantage to convert a carrier workover rig into a trailer workover rig by removing components and adding components to enable transportation with a truck tractor.

### SUMMARY

The disclosure relates to a method of converting a carrier workover rig into a trailer workover rig. The disclosure includes an apparatus of a converted trailer service rig. The disclosure includes taking a carrier service rig, removing components, and adding components to be described in more detail below. The disclosure includes a method of removing the transport system and other equipment from the carrier rig, modifying or adding components to the carrier rig to enable connection to a truck tractor and adding equipment to the carrier rig required to perform well service to be described in detail below. The disclosure includes strengthening the structure and positioning components for proper load distribution, strength, and ergonomics. The disclosure includes an apparatus of a converted trailer rig from a carrier rig including new components, strengthened components, and strategic placement of components. The disclosure includes a method of connecting a truck tractor to a converted trailer rig and transporting the converted rig from location to location.

In some embodiments, a method of converting a carrier rig to a trailer rig is provided. The carrier rig has a carrier rig chassis, a derrick, a cab, a transport engine, and a transmission. The method includes removing one or more of the cab, transport engine, and the transmission from the carrier rig. The method also includes attaching a chassis extension to the carrier rig chassis to form a trailer rig chassis of the trailer rig. The chassis extension is configured to couple to a transport vehicle.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a carrier service rig known in the prior art.

FIG. 2 schematically illustrates another view of the carrier service rig of FIG. 1.

FIG. 3 schematically illustrates an exemplary trailer service rig, according to some embodiments.

FIG. 4 schematically illustrates another view of the trailer service rig of FIG. 3.

FIG. 5 schematically illustrates a partially converted carrier rig chassis of the carrier service rig of FIG. 1.

FIG. 6 schematically illustrates another view of the partially converted carrier rig chassis of the carrier service rig of FIG. 5.

FIG. 7 schematically illustrates an exemplary chassis extension, according to some embodiments.

FIG. 8 schematically illustrates another view of the exemplary chassis extension of FIG. 7.

FIGS. 9 to 12 are sequential views of conversion of a carrier service rig to an exemplary trailer service rig, according to some embodiments. FIG. 9 schematically illustrates an exemplary trailer rig chassis having a chassis extension prior to connection to a carrier rig chassis, according to some embodiments.

FIG. 10 schematically illustrates another view of the partially converted trailer service rig of FIG. 9, according to some embodiments.

FIG. 11 schematically illustrates another view of the partially converted trailer service rig of FIG. 10, according to some embodiments.

FIG. 12 schematically illustrates another view of the partially converted trailer service rig of FIG. 11, according to some embodiments.

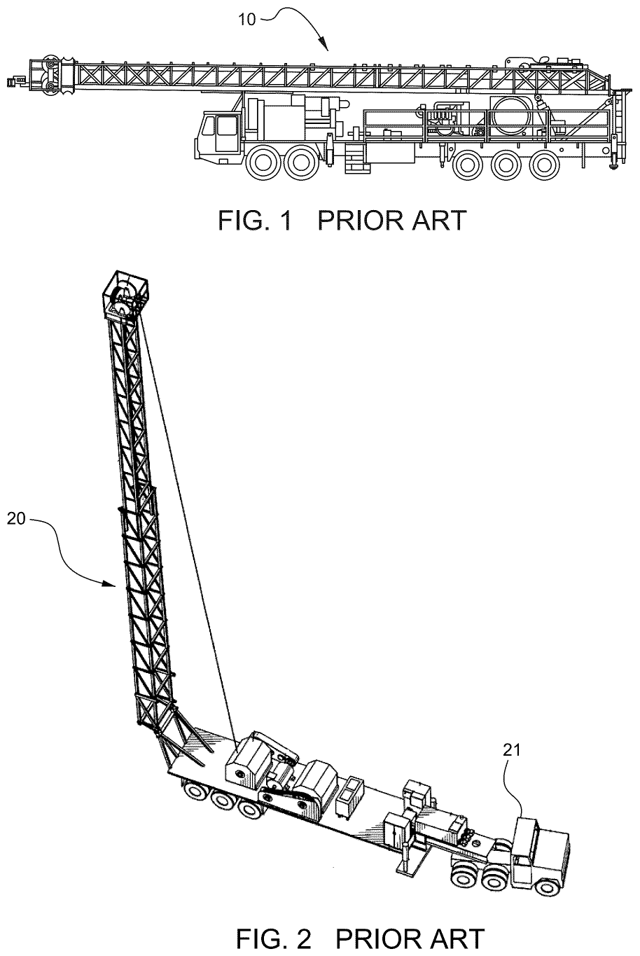

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

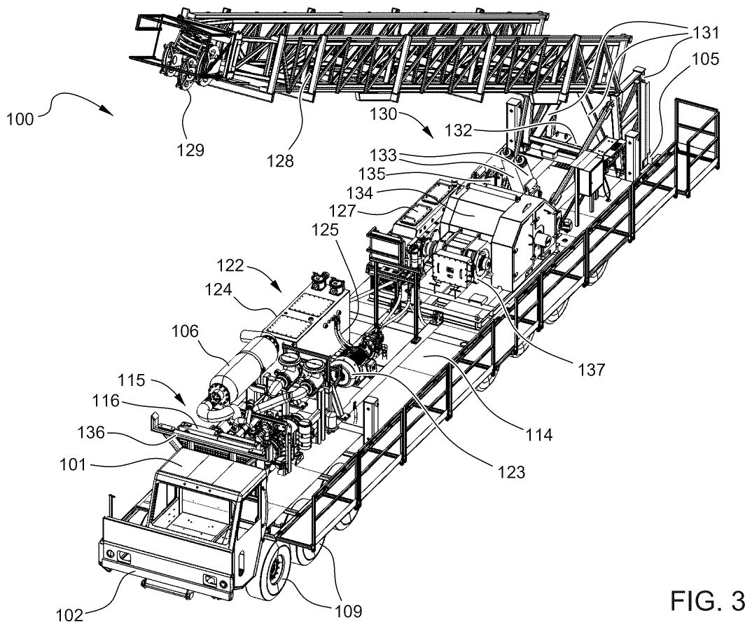

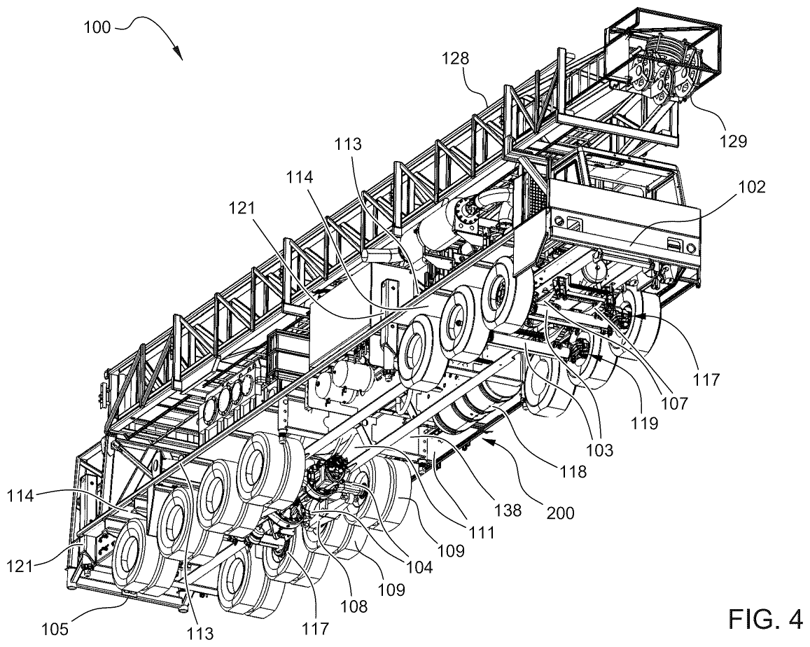

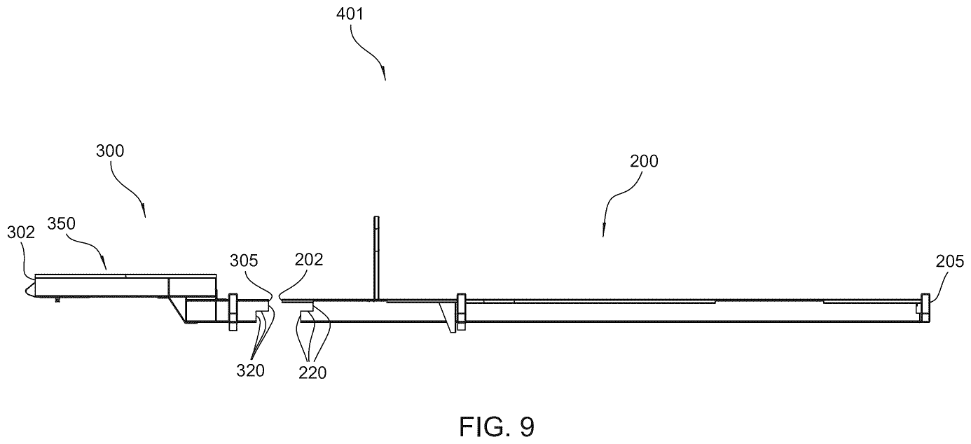

Embodiments of present disclosure include a method of converting a carrier service rig 100 (also referred to as carrier rig 100) having a transportation power system as shown in FIGS. 3 and 4 to a converted trailer service rig 400 (also referred to as trailer rig 400) as shown in FIGS. 9 to 12. The transportation of the converted trailer rig 400 is usually moved by a truck tractor (not shown) known in the transportation industry.

In some embodiments, the carrier rig 100 is moved into a workshop, usually inside of a building with cranes and hoists. In some examples, the carrier rig 100 is moved to any suitable work area with equipment for lifting heavy components and materials.

In some embodiments, a method of converting a carrier service rig 100 includes one or more removing certain components and equipment on the carrier rig 100, leaving selective components on the carrier rig 100, adding certain removed components back, adding new components and equipment to the carrier rig that is undergoing conversion, or combinations thereof. The method is not limited to an exact list of components to remove, to leave, or add back in practicing the disclosure of converting the carrier rig 100 into a converted trailer rig 400.

In some embodiments, calculations on strength, weight distribution, and operational feasibility placement of components are performed. In this respect, when adding one or more components to the converted trailer rig 400, the components are strategically placed to perform well site service work. In some embodiments, the disclosure includes removing components no longer needed or used by the converted trailer rig 400. In some examples, certain components are removed to reduce the weight of the converted trailer rig 400. In some examples, certain components are removed for painting or inspection and will be strategically reattached to the converted trailer rig 400. In some examples, certain components are removed and are replaced by components of a different design, which different design components are strategically located on the converted trailer rig 400. In some examples, certain components will be added that were not a component of the carrier rig as a result of modernization and redesign and are strategically located on the converted trailer rig 400. In some examples, the disclosure includes a method of making the converted trailer rig 400 compliant to heavy trailer highway regulations and laws, such as requirements relating to size, weight, brake ratings, lighting, etc.

An exemplary carrier service rig 100 is shown in FIGS. 3 and 4. The carrier rig 100 includes a cab 101 with driver interfaces (not shown) and an enclosure located towards a front 102 of the carrier. The carrier rig 100 also includes a steering system 119, at least one front steering axle 103 and at least one rear drive axle 104 towards a rear 105 of the carrier rig 100, a front suspension system 107 and a rear suspension system 108, and a plurality of wheels 109 attached to the front steering axles 103 and the rear drive axles 104. The carrier rig 100 further includes a braking system 117, usually of pneumatic operation having pneumatic lines (not shown), for the front and rear axles 103, 104 and associated components. The carrier rig 100 further includes a transport engine (not shown) with associated components such as at least one fuel tank 118, an engine cooling system 115 with a circulation pump and a radiator 116, an air compressor (not shown) powered by the engine, and an associated compressed air storage (not shown) for the braking system 117. The carrier rig 100 includes an exhaust 106 operatively connected to the transport engine. Further included as part of the carrier rig is a transmission (not shown) operatively connected to the transport engine, a drivetrain (not shown) with drive shafts, universals and differentials. The carrier rig 100 further includes an electrical system (not shown) with at least one battery, wires, lights, switches, and motors. The carrier rig 100 has a vehicle identification number and information regarding its classification, manufacturer, vehicle registration, licensing, and motor vehicle insurance. The carrier rig 100 may further include a secondary engine (not shown) dedicated for powering equipment on the rig. The carrier rig may further include mechanical linkages and transmissions for transferring power from the transport engine or secondary engine to the rig equipment.

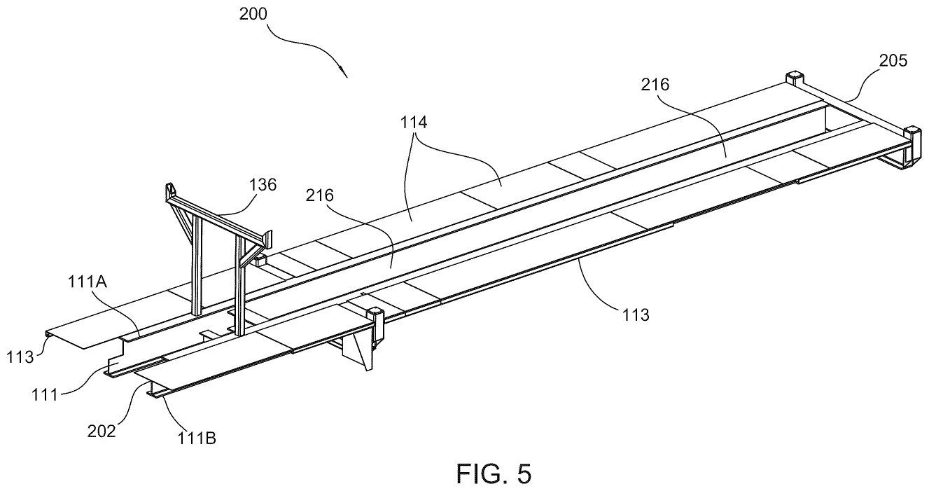

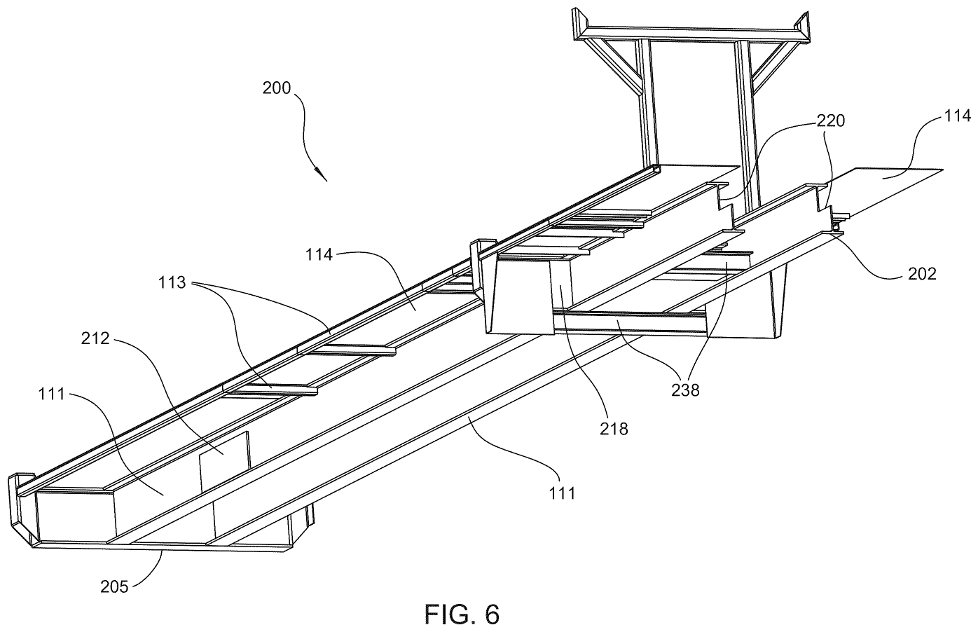

The carrier rig 100 includes a chassis 200 (e.g., base frame) that is usually manufactured using structural steel, as shown in FIGS. 4, 5, and 6. The chassis 200 usually has two I-beams 111 positioned parallel to each other and extend from a front 202 end to a rear 205 of the carrier rig chassis 200. Cross-bracings 138, 238 extend across the parallel I-beams 111 and structurally connect the I-beams 111 to provide strength to the chassis 200. A deck framework 113 is attached to the parallel I-beams 111 for supporting deck plates 114 and extends across the width of the chassis 200. The deck plates 114 are used to mount components and equipment, for personnel mobility, and to add rigidity to the chassis 200 of the carrier rig 100.

The carrier rig 100 further includes a stabilizing system to lift the wheels 109 off the ground and to level the carrier rig 100 while the carrier rig 100 is performing service activities. The stabilizing system includes at least four jacks 121 located strategically around the chassis 200. The stabilizing system may further include a horizontally extending mechanism (not shown) towards the rear 105 operated by hydraulics to further stabilize the carrier rig 100.

The carrier rig 100 includes well service equipment 130 such as a derrick 128 with a crown block 129, a derrick base 131 operatively connected to and between the derrick 128 and the chassis 200, a traveling block and hook, a rig floor 132, at least one hydraulic cylinder 133, a drawworks 134, a power source 137 for powering the drawworks 134, a wire cable running between the drawworks 134 and the derrick 128, a drawworks gearbox 127 operatively connecting the power source 137 to the drawworks 134, at least one winch 135 for lifting equipment near the rig floor 132, a hydraulic motor and pump for well service equipment 130. The well service equipment 130 may further include other components, as is known to a person of ordinary skill.

As shown in FIG. 3, the carrier rig 100 further includes at least one hydraulic cylinder 133 for lifting and pivoting the derrick 128 at the rear 105 of the carrier rig 100 from a collapsed horizontal position enabling transport to a vertical position for well site service work. During transport of the carrier rig 100, the derrick 128 is in the collapsed horizontal position, and a portion of the derrick 128 is supported by a headache rack 136. The headache rack 136 is usually a weldment structure located towards the front 102 of the carrier rig 100.

Embodiments of the present disclosure include disconnecting and removing the operator's cab 101 and one or more associated components. The associated components of the cab 101 that are disconnected and remove include a seat, a steering wheel, a pedal to operate the brakes, transmission clutch, and an accelerator for the transporting engine (not shown). A headache rack 136 for supporting a collapsed derrick 128 is often located directly behind the cab 101, as shown in FIG. 4 in the horizontal position for transport. The headache rack 136 may be disconnected and removed, or the headache rack 136 may remain attached to the carrier rig cassis 200. The cab 101 further includes an instrument panel and other controls (not shown). The cab 101 may further include other associated components required for an operator to control the carrier rig 100 that are removed well known in the art.

The carrier rig 100 further includes the steering system 119, which will be disconnected from the carrier rig 100 and removed. The steering system 119 includes at least one front steering axle 103 and front suspension system 107. The method may include removal of one or more wheels 109. The steering system 119 further includes a steering mechanism (not shown) and associated components between the cab 101 and the front steering axles 103, such as steering arms and steering gear boxes with gears or racks or any known steering linkage known to this type of vehicle. In some embodiments, any steering components associated with the carrier rig 100 well known in the art are disconnected and removed. Any other associated components of the front steering axles 103 may be disconnected and removed.

In some examples, other systems on the carrier rig 100 may be disconnected and removed. For example, the transport engine (not shown) is disconnected from the carrier rig 100 and removed along with the associated transmission. Any driveline components may be disconnected and removed, such as the drive shafts, the universals, and a transfer case. Because the converted trailer rig 400 as shown in FIGS. 9 to 12 no longer has a transport power system, any fuel tanks 118 and exhaust 106 associated with the transport engine are decommissioned and removed. The transport engine cooling system 115 may be disconnected and removed from the carrier rig including the radiator 116 and a circulation pump (not shown) typically connected to the transport engine.

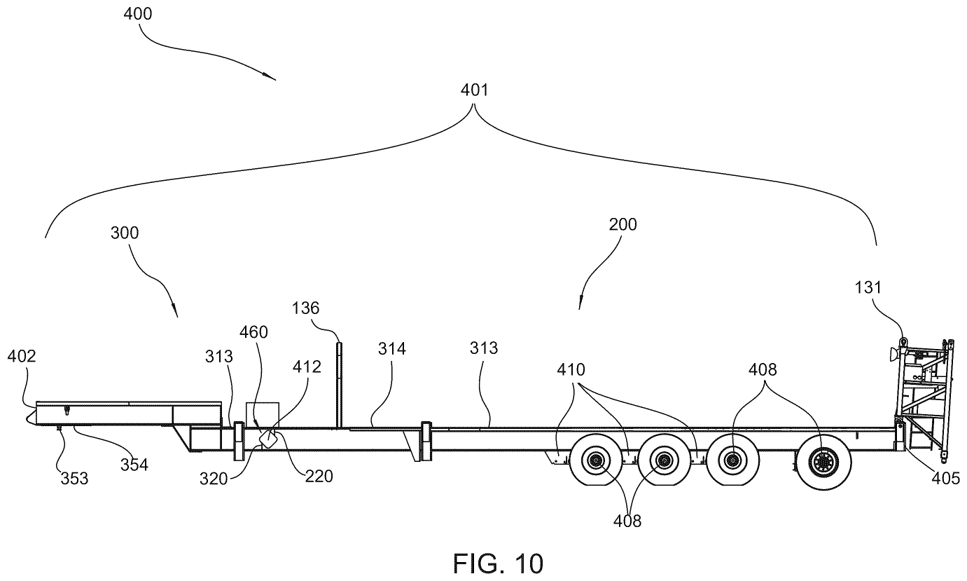

Embodiments of the present disclosure include strategically removing components from the carrier rig 100 that may continue to rotate as the converted trailer rig 400 is in motion during transport. In some examples, the rear axles 104 of the carrier rig 100 and any associated differentials are removed and replaced, for example, with the support axles 408 shown in FIG. 10 that are much lighter in weight.

In some embodiments, conversion of the carrier rig 100 includes disconnecting and removing the braking system 117. The braking system 117 includes pads or shoes and the discs or drums, the pneumatic lines (not shown) or hydraulic lines 125 depending on whether the carrier rig had pneumatically operated or hydraulic operated brakes, and an air compressor and a compressed air storage tank. The air compressor for the pneumatic brakes is usually powered by the transport engine. One or more parts of the braking system 117 are located on at least one front steering axle 103 and at least one rear axle 104. In some examples, one or more components associated with the braking system 117, including the at least one front steering axle 103 and the at least one rear axle 104, are disconnected and removed.

In some examples, the electrical system on the carrier rig 100 is disconnected and removed. The electrical system may include one or more batteries used for starting the transport engine and running electronics. One or more lights such as the headlights, taillights, marker lights, or work lights are disconnected and removed. One or more electrical wires that ran along the length of the carrier rig may be removed.

In some examples, one or more hydraulic systems 122 on the carrier rig 100 may be disconnected and removed. The hydraulic system 122 may be powered mechanically by the transport engine or another engine. The hydraulic system 122 includes a hydraulic pump and motor 123 for providing pressurized fluid to power one or more hydraulic components such as hydraulic motors associated the winch 135 or the hydraulic cylinder 133. Associated components of the hydraulic system 122 may include a hydraulic tank 124 and hydraulic lines 125 and controls. One or more of these components of the hydraulic systems 122 on the carrier rig 100 may be disconnected and removed.

In some examples, the carrier rig 100 includes a separate, secondary engine (not shown) for powering the well service equipment 130 such as the drawworks 134. The present disclosure includes disconnecting, decommissioning, and/or removing the secondary engine if present on the carrier rig 100. Associated components of the secondary engine, such as a secondary fuel tank, and any mechanical components, such as a transmission or gearing, are disconnected and removed.

In some examples, the present disclosure includes disconnecting and removing one or more service equipment 130 associated with well service. For example, the drawworks 134, the winch 135, the derrick base 131, and the derrick 128 can be disconnected and removed from the carrier rig 100. Components associated with the drawworks 134 and derrick, such as the cable lines and pulleys (not shown), may be removed. The hydraulic cylinders 133 may be removed from the carrier rig 100. After removal, the derrick 128 and derrick base 131 may be sent out for regulatory inspection and certification. After the inspection and certification, the derrick 128 and derrick base 131 may be used on the converted trailer rig 400.

During the removal of components and systems from the carrier rig 100, industry guidelines are followed when hazardous materials and liquids are involved. For examples, removed fuel tanks are drained and decommissioned in an appropriate manner. In another example, hydraulic tanks 124 are drained, and the hydraulic fluid is disposed of in accordance to industry and governmental guidelines. Brake fluid is also collected and disposed of in accordance to industry and governmental guidelines. Any hazardous materials or components containing hazardous materials, such as the removed batteries, are disposed of in an appropriate manner.

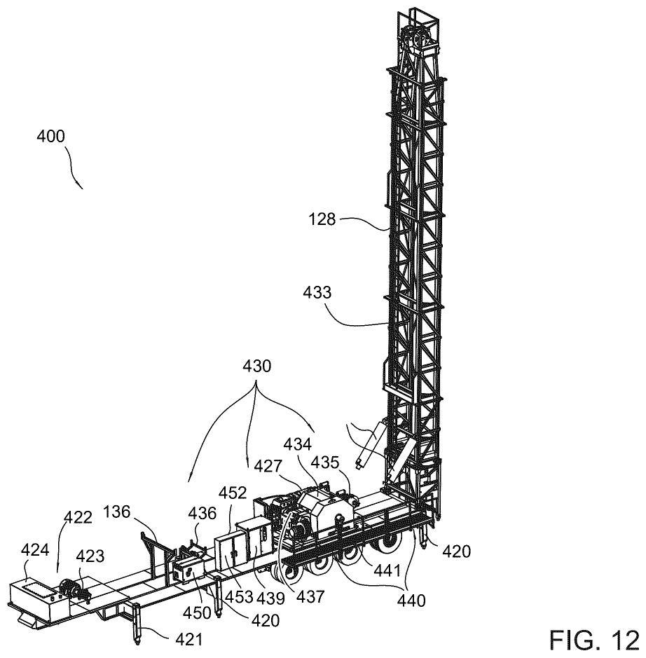

In some embodiments, the method for converting a carrier rig 100 to a converted trailer rig 400 includes one or more of modifying the carrier rig chassis 200 or components remaining on the carrier rig 110, adding new components to the converted trailer rig 400, and reinstalling some components that were removed from the carrier rig 100. In some examples, the removed components are modified before their reinstallation on the converted trailer rig 400. In some examples, the chassis 200 of the carrier rig 100 is modified to increase strength in high stress areas by the addition of reinforcing plates 212, cross-bracing 138, 238, or both. In one example, one or more structural gussets 218 are added between the top flange 111A and bottom flange 111B portions of the I-beams 111 in the web area. The chassis 200 of the carrier rig 100 may have a plurality of open areas 216 such as the area where the cab 101 was removed. One or more deck plates 314 (FIG. 12) may be added to the open area 216 where the cab 101 was removed. The added deck plate 314 may span the width and length of the open area 216 as shown in FIG. 12. The deck plate 314 added to the former cab area may be reinforced by other structural steel. The added deck plate 314 may be lower than the level of the deck plate 114 or the deck plate 314 may be the same level as the deck plate 114. The disclosure may include adding new structural steel to rear of the carrier rig chassis 200 at the rig floor area 132 to increase strength.

In some embodiments, the disclosure includes a method of converting a carrier rig 100 to a trailer rig 400 by calculation and placement of removed equipment and added equipment for proper weight distribution. The location of the equipment installed on the trailer rig 400 is important for stress and load strength and for proper weight balance. When the service rig is in use, i.e., when the derrick 128 is in the vertical position, well equipment is suspended by the derrick 128 with loads in the hundreds of thousands of pounds. Other equipment such as motors, drawworks, winches, tanks and other various equipment that is normally on a service rig is positioned in a location on the trailer rig to balance out the weight to account for the removed cab 101 and the transport engine.

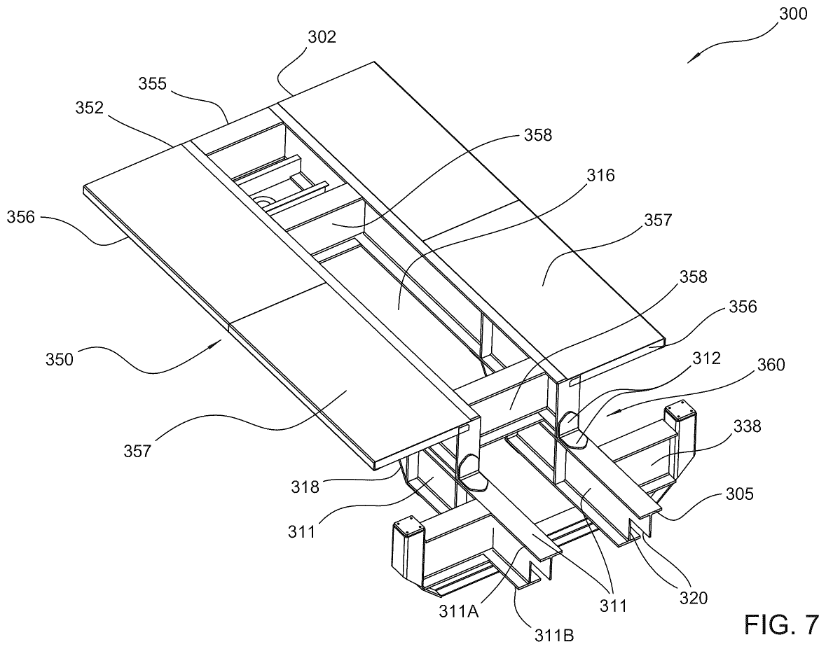

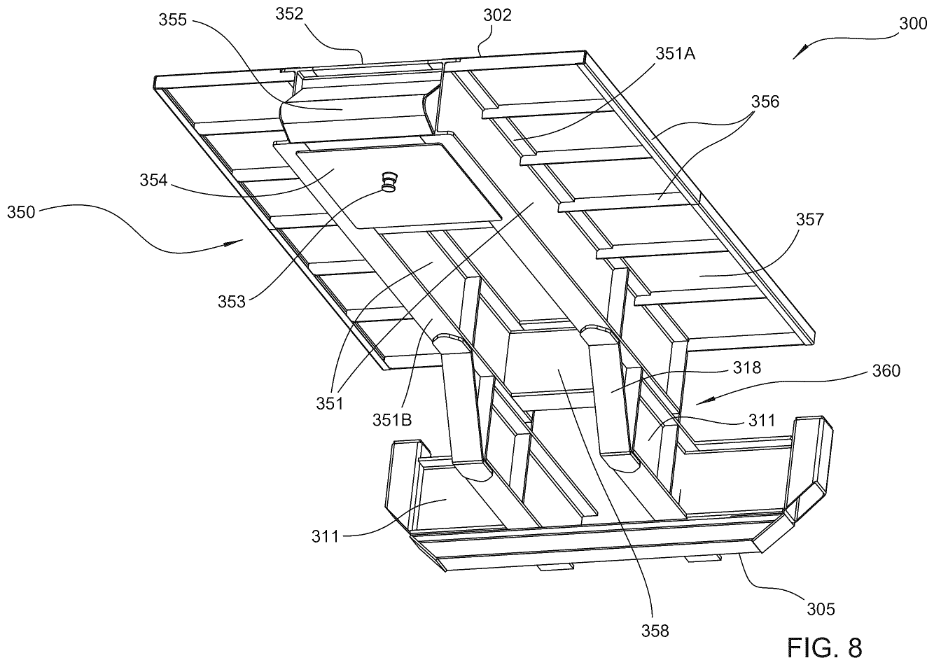

In some embodiments, the length of the carrier chassis 200 is extended by adding a chassis extension 300 as shown in FIGS. 7 and 8 to the carrier rig chassis 200. The chassis extension 300 increases the overall length of the converted trailer rig 400 which allows for the installation of required equipment, for proper load distribution, and for accommodation of the derrick 128 in the horizonal position for transport. The chassis extension 300 may have a structure in the form of parallel I-beams 311 of the same size as the chassis I-beams 111 or may have a structure of any cross-sectional geometry suitable for the conversion. In some examples, the chassis extension 300 may be ten to twelve feet in length. In some examples, the chassis extension 300 may be less than ten feet or more than twelve feet in length. In a preferred embodiment, the chassis extension 300 may be from 3 feet to 30 feet in length. In some examples, one or more cross-bracing 338 are provided to connect the parallel I-beams 311 of the chassis extension 300.

In some examples, a deck framework 313 (FIG. 10) is connected to the chassis extension 300 of FIG. 7 and FIG. 8.

The chassis extension 300 includes a tongue portion 350 as shown in FIG. 7 and FIG. 8. In this example, the tongue portion 350 is constructed of parallel I-beams 351 of the same size as the other I-beams 311 of the chassis extension 300 and carrier rig chassis I-beams 111. The tongue portion 350 of the chassis extension 300 includes features and geometry to enable connection to a truck tractor and to enable the trailer rig to be pulled. In some examples, the parallel I-beams 351 have a top flange 351A and a bottom flange 351B. The framework of the tongue portion 350 may be constructed of any structural material that meets strength and construction requirements. The tongue portion 350 may be connected as a separate weldment connected to the chassis extension 300. In another embodiment, the tongue portion I-beams 351 may be the same continuous structural piece of metal as the chassis extension I-beams 311. A tongue portion deck framework 356 and a tongue portion deck plate 314 may be attached to the I-beams 351, as shown in FIGS. 7 and 8. The tongue portion 350 of the chassis extension may be a weldment of machined parts and structural steel. The tongue portion 350 complies with industry standards such that the converted trailer rig 400 is attachable to and towable by industry standard truck tractors.

In some embodiments, the tongue portion 350 of the chassis extension 300 may be a gooseneck style of tongue that is raised above the rest of the chassis extension 300 to facilitate attachment to a standard receiver of the tractor. An underside contacting surface 354 of the tongue portion 350 as shown in FIG. 8 contacts the receiver surface of the standard truck tractor. The underside surface 354 is at a height substantially the same as the height of the truck tractor receiver surface, thereby enabling the converted trailer rig 400 to be substantially horizontal. The tongue portion 350 may be constructed using larger I-beams than the chassis extension I-beams 311. Reinforcing plates 312 and gusset plates 318 may be welded to an attachment area 360 between the chassis extension 300 and the tongue portion 350 to reinforce high stress areas. The tongue portion 350 may be constructed using comparable strength channel iron or other comparable structural cross-sectional geometry instead of I-beam cross-sectional geometry. One or more additional cross-bracings 358 may be used to connect the parallel I-beams 351 of the tongue portion 350.

The underside contacting surface 354 of the tongue portion 350, located towards the front area 352 of the tongue portion 350, provides a trailer king pin 353 of known strength and geometry to provide a releasable connection to a standard tractor. The tractor may have a fifth wheel type of connection with locking jaws. A bumper 355 may be added to the front area 352 of the tongue portion 350 to provide a smooth surface for hoses and lines (not shown).

The chassis extension 300 may be attached to the carrier rig chassis 200 to form an integrated trailer rig chassis 401 as shown in FIGS. 9 and 10. The chassis extension 300 may be attached to the carrier rig chassis 200 by welding, such as a butt weld at an attachment area 460. Additional reinforcing plates 412 spanning the attachment area 460 are connected to the carrier chassis I-beams 111 and the chassis extension I-beams 311, such as by welding. In some examples, the attachment area 460 is further strengthen by providing a matching stepped interface 220, 320 on the I-beams 111 of the carrier chassis 200 and the I-beams 311 the chassis extension 300. Because the stepped interfaces 220, 320 have a longer attachment length, a longer weld is formed therebetween. In some examples, a cross-bracing connects the two attachment areas 460 on either side of the converted trailer rig chassis 401. It is contemplated the attachment area 460 may have any matching interface geometry such as a straight interface or an interface that is angled from the vertical in order to increase the length of a weld.

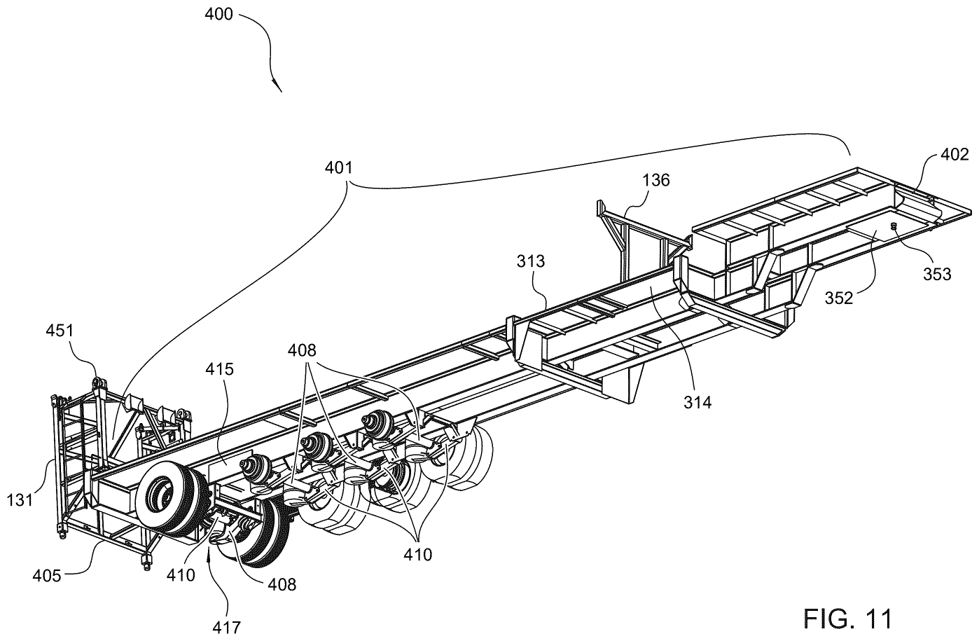

In some examples, additional decking is provided to the converted trailer rig 400 by attaching framework 313 and deck plate 314 to the integrated trailer rig chassis 401 as needed for strength, equipment placement, and weight distribution, as shown in FIG. 12. The extended deck framework 313 may be the same structural steel as the deck framework on the carrier rig chassis 200 or the chassis extension 300, or may be of a different size or strength of structural steel. Gussets, reinforcing plates 415 (FIG. 11) or cross-members may be added anyplace on the integrated trailer rig chassis 401 for additional strengthening. The extended deck framework 313 includes extended deck plates 314 that may be welded to the extended main I-beam chassis and the extended deck chassis. The additional deck framework 313 and deck plate 314 may be attached, usually by welding. The deck plate 314 may include an anti-skid texture. The deck plate 314 may be also used for personnel to walk on. In one embodiment, the added deck plate 314 is not at the same level as the deck plate already on the carrier rig chassis 200 and extended chassis.

In some embodiments, one or more side compartments, not shown, are added to one or more of the carrier rig chassis 200, the chassis extension 300, or the tongue portion 350 of the trailer rig 400. In some embodiments, one or more side panels that may be vertical and connect to the deck framework are added to one or more of the carrier rig chassis 200, the chassis extension 300, or the tongue portion 350 of the trailer rig 400. The added side compartments may be located on the side of the trailer rig 400 or on the front area 352 of the tongue portion 350. Some examples of compartments that can be added include tooling storage compartments, control housing compartments, and battery storage compartments. In some examples, the compartments may be located just under the decking on either side of the trailer rig 400 or at the front 402. Some examples of panels that can be added include one or more panels for electrical, pneumatic, or hydraulic connections. In other embodiments, one or more collapsible cat walks are added to at least one of the sides of the deck 313 to increase the size of the rig walk area.

In some embodiments, one or more rear support axle 408 and associated suspension system 410 are installed on the trailer rig chassis 401. Preferably, the method includes adding four support axles 408 and four suspension systems 410. The rear support axles 408 are non-drive axles and do not include an axle shaft or differential and therefore advantageously reduce the weight of the converted trailer rig 410, which factors into the calculations on strength, weight distribution, and placement. It is contemplated the number of axles to be added may be one, two, three, five or more axles. The suspension systems 410 are connected to the parallel I-beams 111 on the bottom of the trailer rig chassis 401 and are located towards the rear 405 of the trailer rig chassis 401. The suspension systems 410 are strategically positioned based on the results of strength, weight, stability, and functionality calculations performed as part of the conversion method. In some examples, the suspension system 410 is a pneumatic suspension system, but may be a spring suspension system.

In some embodiments, one or more telescoping stabilizing jacks 420, such as four, are added to the integrated trailer rig chassis 401 for leveling and stabilizing the converted trailer rig 400 for well service work. The stabilizing jacks 420 are strategically located according to strength and weight distribution calculations. The stabilizing jacks 420 may be actuated by hydraulics or other actuation methods.

In some embodiments, one or more trailer jack stands 421, such as landing legs, are added toward the front 402 of the integrated trailer rig chassis 401. For example, the trailer jack stands 421 can be added to the chassis extension 300. The jack stands 421 includes an operating system such as a hand crank or a powered system, and vertical legs on either side that may telescope up and down inside of a stationary portion attached to the trailer rig chassis 401 to support the converted trailer rig 400 during disconnection or reconnection to the tractor.

In some embodiments, a walkway system 440 is added to a side of the deck framework 313. The walkway system 440 includes a walking surface 441, which may have a grating or anti-skid texture and is preferably the same level as most of the deck plate 314 on the trailer rig chassis 401. In one example, the walkway system 440 is retractable to facilitate transport of the converted trailer rig 400 on a roadway. The walkway system 440 may be retracted using hydraulics.

In some embodiments, a method of converting the service rig includes installing one or more rig service equipment 430 to the converted trailer rig 400. The rig service equipment 430 may be equipment that was removed from the carrier rig 100, newly added equipment, or both. The newly added equipment may be equipment that was not removed from the carrier rig 100 or equipment that was not present on the carrier rig 100. The rig service equipment 430 may be new or used equipment. The installation of rig service equipment 430 is described below.

In some embodiments, the trailer rig 400 includes drawworks 434 (FIG. 12) operated by a power system 437. In some examples, the power system 437 is an electric motor which may include a cooling system. In some examples, the power system 437 that operates the drawworks 434 is a hydraulic motor. A gearbox 427 operatively connects and may be located between the power system 437 and the drawworks 434. The drawworks 434, the gearbox 427, and the power system 437 may be strategically positioned onto the converted trailer rig 400 based on calculations for weight distribution, strength, and alignment of the drawworks 434 to the derrick 128.

In some embodiments, a hydraulic system 422 is installed onto the converted trailer rig 400. The hydraulic system 422, also known as a HPU, includes a hydraulic pump 423 powered by a motor 425, a hydraulic tank 424, and controls for the hydraulic system 422. The hydraulic pump 423, the motor 425, and hydraulic tank 424 are strategically placed and attached as a result of calculated weight distribution and strength. The hydraulic system 422 is also positioned to maximize the free space on the deck plate 314 for other equipment, personnel mobility, and spatial ergonomics. For example, many equipment previously located towards the front 102 of the carrier rig 100, such as the cab 101, front steering axles 103, front suspension system 107 and associated components, the transport engine, the transmission and associated drivetrain, are no longer present on the trailer rig 400. In this respect, the hydraulic system 422 including the hydraulic tank 424 and the hydraulic pump 423 are preferably placed towards the front 402 of the converted trailer rig 400 on the tongue portion 350 to compensate for the reduced weight as a result of removing the components. In some examples, the placement of the hydraulic tank 424 and hydraulic pump 423 may be positioned on any part of the integrated trailer rig chassis 401 of the converted trailer rig 400. The hydraulic pump 423 of the hydraulic system 422 supplies pressurized hydraulic fluid to power various hydraulically operated equipment, such as hydraulic cylinders 433 or hydraulic motors, such as the power system 437 for the drawworks 434 or winches 435.

In some embodiments, a brake HPU (hydraulic pumping unit) 439 is installed on the trailer rig 400 to supply pressurized hydraulic fluid to brake cylinders operationally connected the drawworks 434. The brake HPU 439 is strategically positioned on the converted trailer rig 400 according to calculations performed on weight distribution and strength. In some examples, the brake HPU 439 is positioned on the rig deck to maximize open space for other equipment, personnel mobility, and spatial ergonomics. In some examples, the brake HPU 439 is positioned and attached towards the front 402 of the converted trailer rig to compensate for removed equipment during conversion of service rig 100 to the trailer rig 400.

In some embodiments, an air compressor 450 is installed on the trailer rig 400 to supply air to run pneumatic equipment during the well service operation. In some examples, a second air compressor system is added to operate the rams of a blowout preventor (BOP), which may optionally be operated by the air compressor 450. The air compressor 450 for operating well service equipment and the second air compressor for operating the BOP are strategically positioned on the converted trailer rig as a result of calculations made for weight distribution, stress and strength requirements, personnel mobility, spatial ergonomics, and operational feasibility.

In some embodiments, some of the components previously disconnected and removed from the service rig 100 are reinstalled onto the converted trailer rig 400. The derrick base 131 and the derrick 128 that were removed and sent out for inspection and certification are reinstalled onto the converted trailer rig 400. In some examples, the derrick base 131 and the derrick 128 are installed at a location toward the rear of the converted trailer rig 400 and operatively connected to the integrated trailer rig chassis 401. In some examples, the derrick 128 and the derrick base 131 are new equipment when installed on the trailer rig 400. The derrick base 131 and derrick 128 are strategically positioned for weight, stress, load, and operational functionality were calculated as part of the method of converting the service rig 100.

In some embodiments, a guywire line weldment 436 for the derrick 128 is installed on the trailer rig 400. The guywire weldment 436 is strategically positioned for weight distribution, personnel mobility, spatial ergonomics, functionality of operation, and strength requirements based on calculation made as part of the conversion of the method. The guywire weldment 436 may have other associated components that are part of the installation on the converted trailer rig 400.

In some embodiments, conversion of the service rig 100 includes installation of an electrical system 453 including electrical controls 452, wiring, relays, lights, etc. on the trailer rig 400. The electrical wiring may be run from electrical power sources to various electrical switches and loads. Part of the electrical system 453 includes wiring for the transportation of the converted trailer rig 400 such as running lights, brake lights, backup lights or any light associated with making the trailer legal to transport on a public road during the day or night. In some examples, the electrical system 453 includes wiring between the electrical system 453 and a generator or a utility grid. In some examples, a separate trailer, not shown, may be pulled to the wellsite and placed close to the converted trailer rig 400. The separate trailer may include a generator, a tank with fuel for the generator, a personnel enclosure, and other electrical equipment that may be used to operate the converted trailer rig. Other electrical equipment may include a variable frequency drive (VFD) and resistors having a resistor cooling system for dissipating electrical energy produced by electrical braking of the drawworks power source 437. In some examples, the electrical system includes or electrically communicate with any well service equipment 430 on the converted trailer rig 400 requiring electrical power, such as the drawworks power source 437, the HPU motor, a brake HPU motor, or a motor to rotate the air compressor for pneumatic equipment.

In some embodiments, conversion of the service rig 100 includes driving a transport vehicle 21 to a location of a converted trailer rig 400 and connecting or disconnecting the transport vehicle 21 to the converted trailer rig 400. In some examples, connecting the transport vehicle 21 to the trailer rig 400 includes one or more of mating the underside contact surface 354 of the converted trailer rig 400 to a receiving surface of the transport vehicle 21, latching the king pin 353 to a receiving mechanism of the transport vehicle 21, or raising the telescoping jack stands 421 such that the front 402 the converted trailer rig 400 is supported by the transport vehicle 21. In some examples, disconnecting the transport vehicle 21 from the trailer rig 400 includes one or more of lowering the telescoping jack stands 421 such that the front 402 the converted trailer rig 400 is supported by the jack stands 421 on the ground, un-mating the underside contact surface 354 of the converted trailer rig 400 from the receiving surface of the transport vehicle 21, unlatching the king pin 353 from the receiving mechanism of the transport vehicle 21, or driving the transportation vehicle away from the converted trailer rig 400. In some embodiments, conversion to the trailer rig 400 includes connecting or disconnecting lines between the transport vehicle 21 and the trailer rig 400 that conduct electricity, pneumatics or hydraulics. The conversion to the trailer rig 400 includes making the trailer rig 400 compliant to governmental regulations for weight, size, use, licensing and financial responsibility.

The disclosure includes an apparatus of a converted trailer rig 400 from a carrier rig 200, according to some embodiments. The converted trailer rig 400 includes a carrier rig portion having a carrier rig chassis 200 including one or more equipment removed therefrom. The one or more removed equipment includes the axles 103, 104, the suspension systems 107,108, the wheels 109, the driver cab 101 with a driver interface, the steering system 119, the transporting power system with drivetrain, the braking system 117, or any well service equipment 130 to be removed. The carrier rig chassis 200 has a front end 202 and a rear end 205 and may be constructed using parallel I-beams 111 structural steel with a top flange 111A, a bottom flange 111B and a web. The carrier chassis 200 may have a deck plate 314 attached to the top of and extending between the parallel I-beams 111.

In some embodiments, the converted trailer rig 400 includes an integrated converted trailer rig chassis 401 which includes the carrier rig chassis 200 and the chassis extension 300. The chassis extension 300 has a front end 302 and a rear end 305 and may be constructed using parallel I-beams 311, made of structural steel, with a top flange 311A, a bottom flange 311B, and a web. The front end 202 of the carrier rig chassis 200 is attached to the rear end 305 of the chassis extension 300 at an attachment area 460. In some examples, the attachment area 460 includes a matching stepped interfaces 220, 320 that preferably has a weld. The attachment area 460 may have a plurality of reinforcing plates 412 attached to both the carrier rig chassis 200 and the chassis extension 300. The reinforcing plates 412 of the attachment area 460 may be attached to the carrier rig chassis 200 and the chassis extension 300 using a weld. In some examples, the parallel I-beams 111 of the carrier rig chassis 200 and the parallel I-beams 311 of the chassis extension 300 are connected together using cross-bracing 138, 238 made of structural steel that may be I-beams, H-beams or channel, giving the chassis rigidity.

In some embodiments, the chassis extension 300 includes a tongue portion 350. The tongue portion 350 may be part of front end 302 of the chassis extension 300. In some examples, the tongue portion 350 may be a separate tongue portion 350 attached to the chassis extension 300 at an attachment area 360. The tongue framework may be constructed using parallel I-beams 351 structural steel with a top flange 311A and a bottom flange 311B and a web. The attachment area 360 may include a joining interface that may be a weld. In some examples, the attachment area 360 may include reinforcing plates. The reinforcing plates of the attachment area 360 may be attached to the tongue portion framework and the remainder of the chassis extension 300 using a weld. The tongue portion 350 is adapted to be connectable to a transport vehicle for transportation along a public road or for transportation from site to site. In some examples, the tongue portion 350 includes a connecting area with an underside contact surface 354 and a king pin 353. The underside contact surface 354 and the king pin 353 are adapted to be received by a fifth wheel of the transport vehicle, such as a standard truck tractor. The tongue portion 350 may be at a level such that the bottom flange 351B of the tongue portion I-beam 351 is substantially the same height as the top flange 311A of the chassis extension I-beam 311. In some examples, the tongue portion 350 may be at a level where the bottom flange 351B of the tongue portion I-beam 351 is higher or lower than the height of the top flange 311A of the chassis extension I-beams 311. In some examples, the converted trailer rig 400 includes one or more cross-bracings 238, 338, 358, 438 attached to the integrated trailer rig chassis 401. The cross-bracings 238,338,358,438 are added to high stress and high load areas.

In some embodiments, the converted trailer rig includes at least one support axle 408 and suspension system 410 attached to the integrated trailer rig chassis 401. The converted trailer rig may includes a braking system 417, wheels and tires attached to the at least one support axle 408 and suspension system 410.

In some embodiments, the converted trailer rig includes a deck framework 313 attached to the combined chassis 200, 300 and a deck plate 314 attached to the deck framework and the combined chassis 200, 300. The deck plate 314 may also span the I-beams 111 the carrier rig chassis 200 and the chassis extension 300. The deck 313 is used for placement of equipment, for personnel mobility, or both.

The apparatus of a trailer service rig converted from a carrier service rig includes a derrick base 131 attached to the combined chassis 401 and a derrick 128 pivotably attached to the derrick base 131. The derrick 128 is lowered into a horizontal position on the converted trailer rig for transport from location to location. The derrick 128 is raised to a vertical position for well service work. In some examples, the derrick base 131 includes at least one pivoting structure 451 having a pivoting axis. The derrick 128 has at least one mating pivoting structure having a pivoting axis that pivotably connects to the pivoting structure 451 of the derrick base 131. In some examples, hydraulic cylinders 433 are used to lift the derrick 128 from the horizontal position to the vertical position for well service work and to lower the derrick 128 from the vertical position for transport of the rig. While in the horizontal position, the top portion of the derrick 128 rests on the headache rack 136 for stability. The headache rack 136 may be a remaining part of the former carrier rig chassis 100, or the headache rack 136 may be newly added to the trailer rig chassis 401.

In some examples, a jack stand system is attached to either the carrier rig chassis 200, the chassis extension 300, or both. The jack stand system includes a plurality of jack stands 421 to support the service trailer rig 400 during the period of disconnection or connection to the transport vehicle. In some examples, the jack stands 421 include vertical legs that may telescope up and down inside of a stationary portion attached to the trailer rig chassis 401, such as by welding. In some examples, the jack stand system also includes an operation system that may include a hand cranking gearing system or a worm gearing system. It is contemplated any suitable type of trailer jack system known in the transportation industry could be used as part of the method of converting the service rig 100 to a trailer rig 400.

In some examples, the converted trailer rig 400 includes a power system 437 for powering the drawworks 434 attached to the service rig chassis and used to raise or lower a hook and to perform well service work. In some examples, the power system 437 includes an electric motor having a cooling system. In some examples, the power system 437 includes a hydraulic motor. The converted trailer rig 400 may also include a first air compressor 450 for powering pneumatic equipment on the trailer rig 400 and an optional second air compressor dedicated for actuation of a BOP. The first air compressor to power pneumatic equipment may be attached to the trailer rig chassis 401, such as being attached to the deck plate 314. The second air compressor used to energize BOP rams is also attached to the combined chassis 401, such as being attached to the deck plate. In some examples, the converted trailer rig 400 includes other equipment such as a hydraulic pumping unit 422 (HPU). The HPU 422 includes an electric motor operatively connected to a hydraulic pump 423 used to pressurize hydraulic fluid for operating various hydraulically operated equipment on the trailer rig 400. In some examples, the converted trailer rig 400 includes hydraulically operated motors, winches, and the hydraulic cylinders used to raise and lower the derrick 128. Additional equipment may be installed onto the converted trailer rig 400 for winterization, such as a wind breaker side panel (not shown).

In some embodiments, a method of converting a carrier rig to a trailer rig is provided. The carrier rig has a carrier rig chassis, a suspension system, a transport system, and rig service equipment. The method includes removing one or more of the suspension system, the transport system, or the rig service equipment. The method also includes attaching a chassis extension to the carrier rig chassis to form a trailer rig chassis of the trailer rig. The chassis extension is configured to couple to a transport vehicle.

In some embodiments, a trailer service rig is converted from a carrier service rig. The trailer service includes a carrier rig chassis of the carrier service rig and a chassis extension attached to a front end of the carrier rig chassis. The chassis extension displaces a transport system of the carrier rig. The trailer service also includes a derrick coupled to a rear end of the carrier rig chassis and drawworks disposed on the carrier rig chassis. The trailer service rig also includes one or more rear support axle attached to the carrier rig chassis. The chassis extension has a connecting area including an underside contact surface configured to couple with a transport vehicle

It is contemplated that any one or more elements or features of any one disclosed embodiment or example may be beneficially incorporated in any one or more other non-mutually exclusive embodiments or examples. While the foregoing is directed to embodiments of the present disclosure, other and further embodiments of the disclosure may be devised without departing from the basic scope thereof, and the scope thereof is determined by the claims that follow.

1. A method of converting a carrier rig to a trailer rig, comprising:
providing a carrier rig having a carrier rig chassis, a suspension system, a transport system, and rig service equipment;
removing one or more of the suspension system, the transport system, and the rig service equipment; and
attaching a chassis extension to the carrier rig chassis to form a trailer rig chassis of the trailer rig, the chassis extension configured to couple to a transport vehicle.

2. The method of claim 1, further comprising removing from the carrier rig at least one of a front steering axles, front wheels, a front suspension system, a fuel tank, an exhaust, a cooling system for the transport engine, a braking system, a battery for starting the transport engine, and a headlight.

3. The method of claim 1, wherein the derrick is located at a rear end of the carrier rig chassis, and attaching the chassis extension comprises attaching the chassis extension to a front end of the carrier rig chassis.

4. The method of claim 3, wherein the chassis extension includes a step surface for attaching to a mating step surface of the carrier rig chassis.

5. The method of claim 3, further comprising attaching a reinforcement plate to the chassis extension and the carrier rig chassis.

6. The method of claim 3, wherein the chassis extension includes a connecting area having an underside contact surface and a king pin for coupling to the transport vehicle.

7. (canceled)

8. The method of claim 3, wherein the carrier rig chassis includes a plurality of I-beams, and the method further comprises attaching one or more gussets to the I-beams.

9. The method of claim 8, wherein attaching the chassis extension to the front end of the carrier rig chassis comprises attaching the plurality of I-beams of the carrier rig chassis to a plurality of I-beams of the chassis extension.

10. The method of claim 1, further comprising removing the derrick from the carrier rig chassis, inspecting the derrick, and reinstalling the derrick on the trailer rig chassis.

11. The method of claim 1, wherein the chassis extension includes a deck and a deck plate attached to two I-beams.

12. (canceled)

13. The method of claim 1, further comprising installing one or more telescoping stabilizing jacks and one or more trailer jack stands to the trailer rig chassis.

14. The method of claim 13, wherein the one or more trailer jack stands are installed on the chassis extension.

15. The method of claim 1, further comprising installing drawworks and a power system for operating the drawworks on the trailer rig.

16. The method of claim 15, wherein the drawworks and the power system were removed from the carrier rig and reinstalled on the trailer rig.

17. (canceled)

18. The method of claim 1, further comprising installing a brake hydraulic pumping unit toward a front portion of the carrier rig chassis forming the trailer rig chassis.

19. The method of claim 1, further comprising installing an air compressor on the trailer rig chassis to supply air to operate pneumatic equipment.

20. (canceled)

21. The method of claim 1, further comprising installing a guywire line weldment on the trailer rig chassis.

22. The method of claim 1, further comprising coupling the trailer rig to the transport vehicle, and transporting the trailer rig to a wellsite.

23. (canceled)

24. A trailer service rig converted from a carrier service rig, comprising:
a carrier rig chassis of the carrier service rig;
a chassis extension attached to a front end of the carrier rig chassis, wherein the chassis extension displaces a transport system of the carrier rig;
a derrick coupled to a rear end of the carrier rig chassis;
drawworks disposed on the carrier rig chassis;
one or more rear support axle attached to the carrier rig chassis; and
the chassis extension having a connecting area including an underside contact surface configured to couple with a transport vehicle.

25. The trailer service rig of claim 24, wherein the chassis extension includes a step surface for attaching to a mating step surface of the carrier rig chassis.

26.-32. (canceled)
